(19) United States
(12) Patent Application Publication
(10) Pub. No.: US 2007/0247457 A1
(43) Pub. Date: Oct. 25, 2007

(54) Device and Method for Presenting an Image of the Surrounding World

(76) Inventors: Torbjorn Gustafsson, Linkoping (SE); Per Carleberg, Stockholm (SE)

Correspondence Address: JACOBSON HOLMAN PLLC, 400 SEVENTH STREET N.W., SUITE 600, WASHINGTON, DC, 20004, US

(21) Appl. No.: 11/630,200

(22) PCT Filed: Jun. 21, 2005
(86) PCT No.: PCT/SE05/00974

§ 371 Date: Dec. 21, 2006

(30) Foreign Application Priority Data
Jun. 21, 2004 (SE) 0401603-6

(51) Int. Cl. G06T 17/00

(52) U.S. Cl. 345/420; 345/8

(57) ABSTRACT

A device and a method for displaying an image of the surroundings to a user (90), comprising an image sensor device (10), which records image information of a surrounding world, connected via a transmission device (20) to a central unit (30), and a head-mounted display device (40), where the central unit (30) displays images from the image sensor device (10). The invention comprises that the central unit (30) generates a virtual 3D world where image information (8) is projected in real time from the image sensor device (10) as textures in a 3D world. Parts of the 3D world are then displayed on the display device (40) in real time.

The invention relates to a device and a method for displaying, by indirect vision, an image of the surroundings to a user.

In military contexts, it is important to have a visual perception of the surrounding world. As a rule, the surrounding world is registered directly by the eyes or an optical periscope. Such periscopes can be found, for instance, in combat vehicles or in submarines. However, new requirements and threats have created a need to obtain a perception of the surroundings by image sensors, usually cameras, whose image data is displayed on, for instance, a display. Such a method can be referred to as indirect vision. Image data is recorded and displayed in these contexts in real time, which here means at such an image rate that a user experiences a continuity in movements. 20 images/s are usually considered to be the minimum for real time but the rate may in some contexts be lower.

There are several reasons to use indirect vision. One reason is to be able to record image information which cannot be seen by the eye. By using, for instance, image sensors of the Night Vision type or image sensors that are sensitive to thermal IR radiation, the perception of the surroundings can be allowed or strengthened. Another reason for indirect vision is to protect the eyes against eye-damaging laser radiation. In addition, in military contexts a combat vehicle may expose itself by the light or radiation emitted from the illuminated interior through an optical periscope.

The images that can be displayed to a user via indirect vision can originate from an image sensor device, in real time or recorded, from a virtual environment or as a combination of these. An image sensor device may comprise, for instance, one or more video cameras that are sensitive to the visual range, IR cameras sensitive in one of the IR bands (near IR, 3-5 μm, 8-12 μm), UV cameras or other direct or indirect image-generating sensor systems, for instance radar or laser radar. Images from different sensor systems can be combined by data fusion and be displayed to the user.

In a system for indirect vision, the image sensors need not be arranged in the vicinity of the user. The user can be positioned in an optional physical place, separate from the image sensors, but virtually be in the place of the sensors. For the user to obtain good perception of the surroundings, it should be recorded and displayed in a field of vision that is as large as possible since this is the way in which we naturally experience the surroundings. However, this cannot always be arranged; for instance, there is not much space for large displays in a combat vehicle. A way to solve this problem is to provide the user with a head-mounted display device, for instance consisting of one or more miniaturised displays which can be viewed by magnifying optics or a device projecting/drawing images on the retina of the user's eye.

When using a head-mounted display device, an image can be displayed to a single eye, monocular display. When using two displays, the same image can be displayed to both eyes, biocular display, or two different images are displayed, binocular display. In binocular display a stereoscopic effect can be achieved. By using, for instance, two additional displays, an effect of peripheral vision can be achieved. The displays can preferably indirectly be secured to the user's head by means of a device in the form of a spectacle frame or helmet.

The visual impression normally changes as the user moves his head. The image which, via a head-mounted display, is displayed to a user is normally not affected by the user's head moving relative to the surroundings. The feeling of not being able to change the visual impression by movements may by most people using head-mounted displays be experienced as frustrating after a while. The normal behaviour of scanning the surroundings by moving the head and looking around does not work.

A solution to this is to detect the position and direction of the user's head by a head position sensor. The image displayed to the user on the head-mounted display can then be adjusted in such a manner that the user experiences that he can look around.

By using indirect vision, where the user carries a head-mounted display device and where the position and direction of the user's head are detected, the user in a combat vehicle can get the feeling of looking through the walls of the vehicle, “See-Through-Armour”, hereinafter abbreviated as STA.

An image sensor device can be mounted on gimbals movable in several directions. The gimbals, which can be controlled from the head position sensor, should be very quick as regards their capacity of rotating per unit of time as well as acceleration/retardation. This ensures that the user does not experience disturbing delays in quick movements of his head. Gimbals are a complicated apparatus with a plurality of moving parts. In the case of indirect vision, the gimbals can be controlled only by a single user. This is a drawback since it prevents other users from practically receiving information from the image sensor system.

An alternative to mounting the image sensor on gimbals is to use an image sensor device which records the surroundings by means of several image sensors where each image sensor records a subset of a large environment.

Such a system is known from the article “Combat Vehicle Visualization System” by R. Belt, J. Hauge, J. Kelley, G. Knowles and R. Lewandowski, Sarnoff Corporation, Princeton, USA, published on the internet at the address http://www.cis.upenn.edu/˜reich/paper11.htm. This system is called “See Through Turret Visualization System” and is here abbreviated as STTV.

In the STTV, the images from a multicamera device are digitised by a system consisting of a number of printed circuit cards with different functions. The printed circuit cards contain, inter alia, image processors, digital signal processors and image stores. A main processor digitises the image information from the multicamera device, selects the image information of one or two cameras based on the direction of a user's head, undistorts the images, that is corrects the distortion of the camera lenses, and then puts them together without noticeable joints in an image store and then displays that part of the image store that corresponds to the direction of the user's head. The STTV manages to superimpose simple 2-dimensional, 2D, virtual image information, for instance cross hairs or an arrow indicating in which direction the user should turn his head. The direction of the user's head in the STTV is detected by a head position sensor which manages three degrees of freedom, that is head, pitch and roll.

A user-friendly STA system which has a larger field of application could, however, be used in a wider sense than merely recording, superimposing simple 2D information and displaying this image information.

The invention concerns a device and a method which by a general and more flexible solution increases this. The solution is defined in the independent claims, advantageous embodiments being defined in the dependent claims.

The invention will be described in more detail with reference to the accompanying Figures.

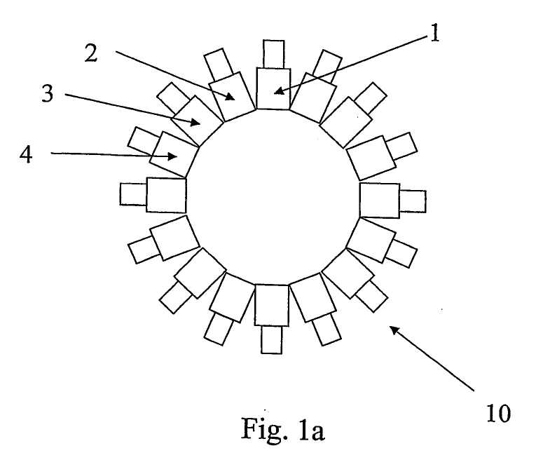

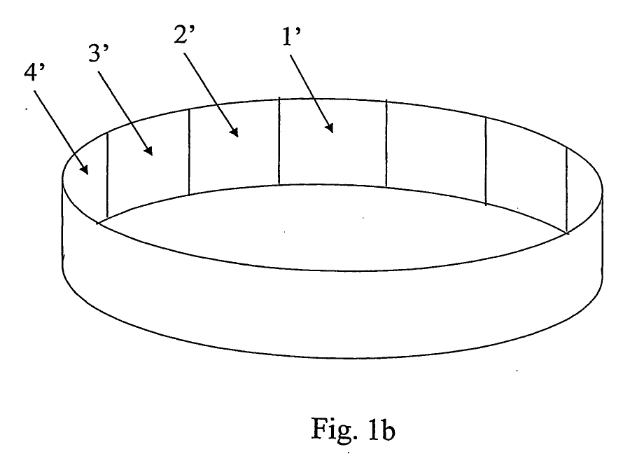

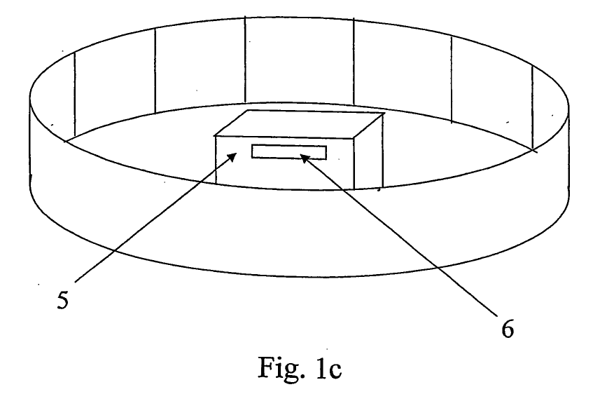

FIGS. 1a-c show an image sensor device and a 3D model.

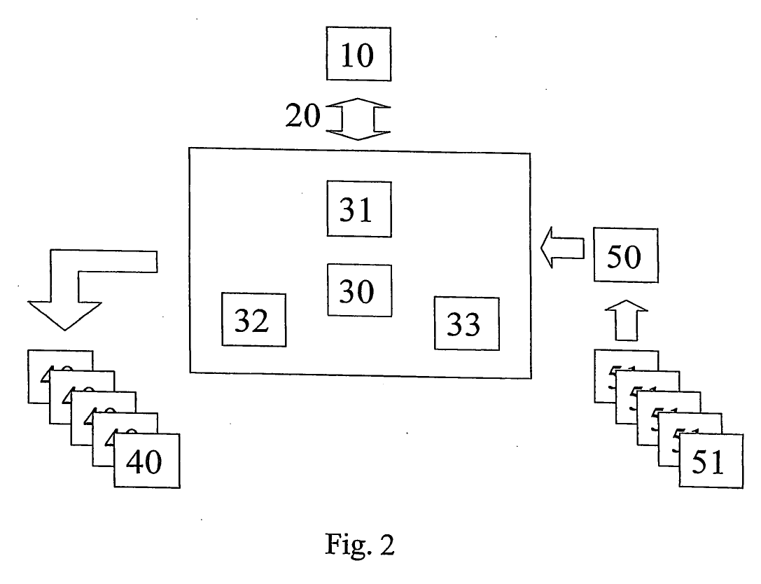

FIG. 2 is a principle sketch of an embodiment of the invention.

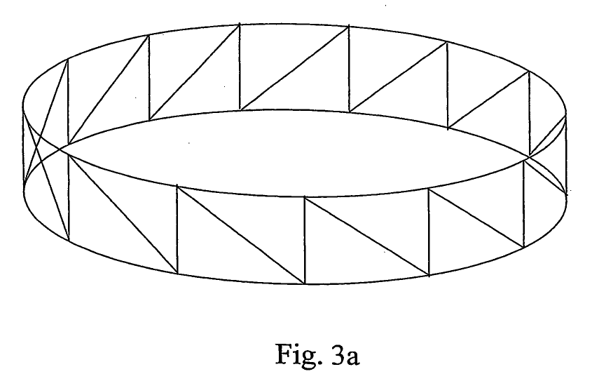

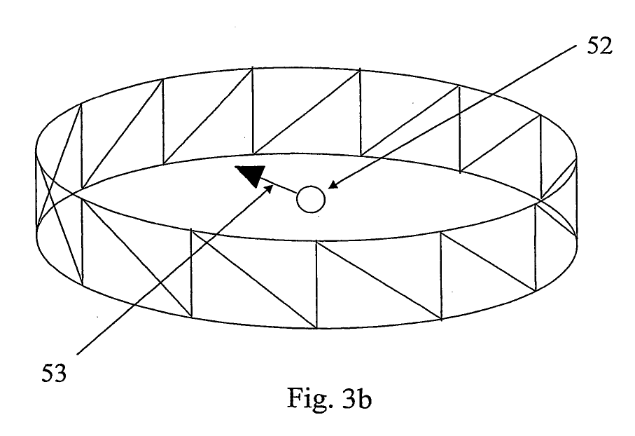

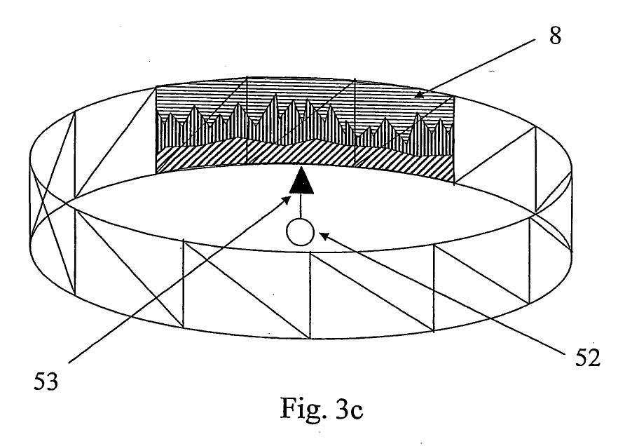

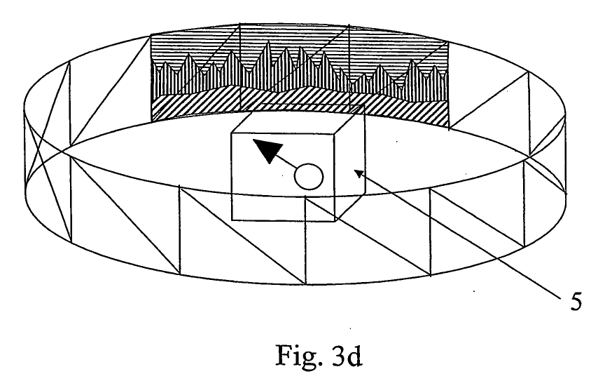

FIGS. 3a-d illustrate a 3D model.

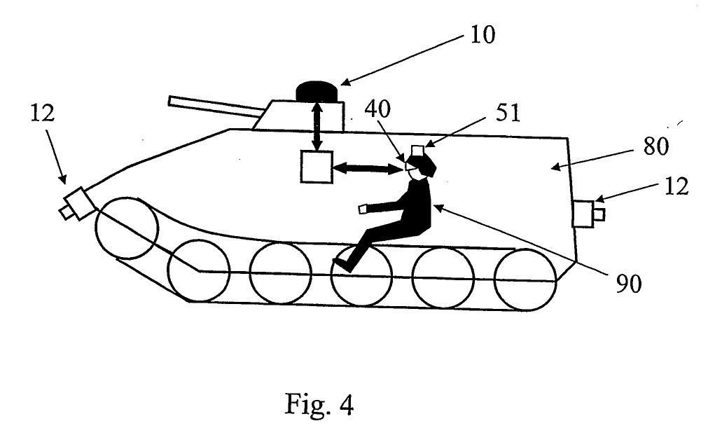

FIG. 4 shows a vehicle with a device according to the invention.

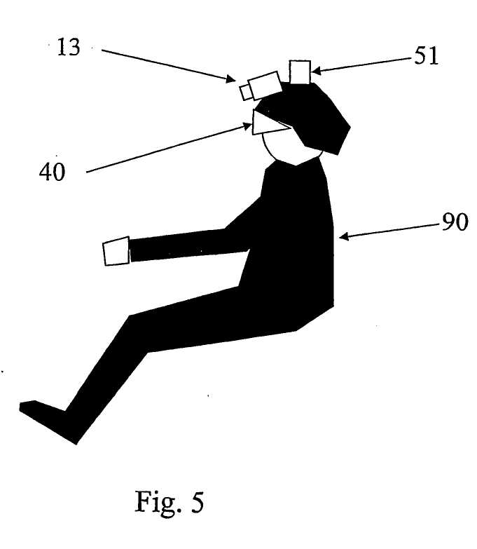

FIG. 5 shows a user with a head-mounted display device.

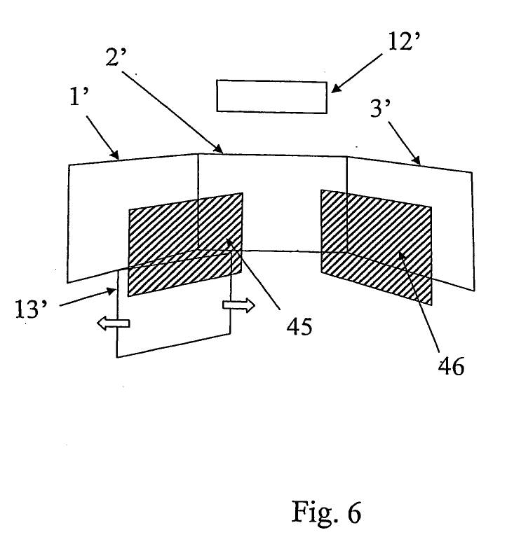

FIG. 6 shows image information to the user's display device.

FIG. 1 a shows an example of an image sensor device (10). The image sensor device (10) comprises a number of image sensors, for instance cameras (1, 2, 3, 4) which are arranged in a ring so as to cover an area of 360 degrees. The images from the cameras (1, 2, 3, 4) are digitised and sent to a central unit (30, see FIG. 2). The central unit (30) comprises a computer unit with a central processing unit (CPU), a store and a computer graphics processing unit (32). Software suitable for the purpose is implemented in the central unit (30).

In the central unit (30) the images are imported as textures into a virtual 3D world which comprises one or a plurality of 3D models. Such a model can be designed, for instance, as a cylinder (see FIG. 1b) where the textures are placed on the inside of the cylinder. The image of the first camera (1) is imported as a texture on the first surface (1′), the image of the second camera (2) is imported on the second surface (2′) etc. The images can also be imported on a more sophisticated 3D model than the cylinder, for instance a semi-sphere or a sphere, preferably with a slightly flattened bottom.

In the case according to FIG. 1b, the 3D world can be developed by a virtual model of, for instance, a combat vehicle interior being placed in the model that describes the cylinder (see FIG. 1c). FIG. 1c schematically shows the model of the interior (5) and a window (6) in the same. The point and direction from which the user views the 3D world are placed, for instance, in the model of the interior (5) (see FIG. 3d). This point and direction are obtained from a position sensor, for instance a head position sensor (51) (see FIG. 4). The advantage of importing a model of an interior into the 3D world is that the user can thus obtain one or more reference points.

FIG. 2 is a principle sketch of an embodiment of the invention. An image sensor device (10) comprising a number of sensors, for instance cameras according to FIG. 1a, is mounted, for instance, on a vehicle according to FIG. 4. In the embodiment shown in FIG. 1a, the image sensors cover 360 degrees around the vehicle. The image sensors need not cover the entire turn around the vehicle but in some cases it may be sufficient for a sub-quantity of the turn to be covered. Additional image sensors can be connected, for instance for the purpose of covering upwards and downwards, concealed angles, and also sensors for recording outside the visible range.

The image sensor device (10) also comprises a device for digitising the images and is connected to a transmission device (20) to communicate the image information to the central unit (30). The communication in the transmission device (20) can be unidirectional, i.e. the image sensor device (10) sends image information from the sensors to the central unit (30), or bidirectional, which means that the central unit (30) can, for instance, send signals to the image sensor device (10) about which image information from the image sensors is currently to be transmitted to the central unit (30). Since the transmission preferably occurs with small losses of time, fast transmission is required, such as Ethernet or Firewire.

The central unit (30) comprises a central processing unit (CPU) with memory, an interface (31) to the transmission device (20), a computer graphics processing unit (GPU) which can generate (visualise) a virtual 3D world, a control means in the form of software which by data from a position sensor (50) can control which view of the 3D world is shown on a display device (40). The position sensor (50) can be a mouse or the like, but is preferably a head-mounted head position sensor (51) which detects the position (52) and viewing direction (53) of the user (see FIG. 3b). Based on data from the head position sensor (51), the user is virtually positioned in the virtual 3D world. As the user moves, data about this is sent to the central unit (30) and to the computer graphics processing unit (32) that calculates which view is to be displayed to the user.

Generally in a computer graphics system, a virtual 3D world is made up by means of a number of surfaces which can be given different properties. The surface usually consists of a number of triangles which are combined in a suitable manner to give the surface its shape, for instance part of a cylinder or sphere. FIG. 3a shows how a virtual 3D world is made up of triangles. A 2-dimensional image can be placed in these triangles as a texture (see FIG. 3c). Textures of this type are static and can consist of not only an image, but also a colour or property, for instance transparent or reflective. As a rule the textures are imported on a specific opportunity and are then to be found in the 3D world.

According to the invention, the device and the method use image information from the image sensor device (10) and import it as textures into a 3D world. These textures are preferably imported in real time into the 3D world, that is at the rate at which the image sensors can record and transmit the image information to the central unit (30). The computer graphics processing unit (32) then calculates how the 3D world with the textures is to be displayed to the user (90) depending on position (52) and viewing direction (53).

Also other virtual image information can be placed in the 3D world. A virtual 3D world of an interior (5) of a vehicle, with controls, steering wheel, the area around a windscreen with bonnet and beams, can be placed in the 3D world and thus give the user one or more reference points. In addition, virtual rearview and wing mirrors can be arranged to display image information from suitable image sensors. FIGS. 5-6 also show how image information from sensors in the vicinity of the user, for instance on the head of the user, can be used.

FIG. 4 illustrates a vehicle with a device according to the invention. The sensor device (10) comprises a number of cameras, for instance according to FIG. 1. Also additional cameras (12) can be placed on the vehicle to cover areas which are concealed or hidden, for instance a rearview camera. A user (90) with a head-mounted display device (40) and a head-mounted position device (51) is sitting in the vehicle (80).

FIG. 5 shows another embodiment of the invention. The user (90) has a head-mounted display device (40), head position sensors (51) and also a sensor device comprising a camera (13) arranged close to the user, in this case on the head of the user. The camera (13) is used to show images from the driver's environment to the user. The display device (40) often takes up the entire field of vision of the user, thus resulting in the user not seeing the controls when he looks down at his hands, controls or the lice. A camera (13) mounted in the vicinity of the user (90), for instance on his head, can assist the user by sending image information about the immediate surroundings to the central unit which imports the image information into the 3D world.

FIG. 6 shows how image information from different cameras is assembled to one view that is displayed to the user. A 3D world is shown as part of a cylinder. The dark field (45) represents the field of vision of the user displayed via a display device (40). The other dark field (46) shows the equivalent to a second user. In the field (45) a part of the image from the camera (13) is shown, the information of which is placed as a dynamic texture on a part (13′) of the 3D world. This dynamic texture is, in turn, displayed dynamically, that is in different places, and is controlled by the position and direction of the head of the user, in the 3D world. The image from, for instance, a rearview camera (12) can be placed as a dynamic texture on a part (12′) of the model of the surroundings and function as a rearview mirror.

Image information from the camera device according to FIG. 1a, for instance from two cameras, surfaces (1′,2′) and also from a head-mounted camera, like in FIG. 5, can be displayed to the user. The image information from the different cameras can be mixed together and displayed to the user. To display an image to the user, a plurality of the sensors of the image sensor device may have to contribute information. The invention has no restriction as to how much information can be assembled to the user's image.

The method according to the invention will be described below. The method displays an image of the surroundings on one or more displays (40) to a user (90). An image sensor device (10) records image information (8) of the surroundings. The image information (8) is transmitted via a transmission device (20) to a central unit (30). The central unit (30) comprising a computer graphics processing unit (32) generates (visualises) a virtual 3D world, for instance part of a virtual cylinder like in FIG. 3, or, in a more advanced embodiment, in the form of a semi-sphere or a sphere.

Based on information from a position sensor, the user (90) is virtually placed in the virtual 3D world. The position sensor (50), conveniently in the form of a head position sensor (51), can detect up to 6 degrees of freedom and sends information about the position (52) and the viewing direction (53) of the user to the central unit (30). Based on where and in what viewing direction the user is positioned in the 3D world, the central unit (30) calculates what image information is to be displayed via the display device (40). As the user (90) moves or changes the viewing direction, the central unit (30) automatically calculates what image information (8) is to be displayed to the user. The central unit (30) requests image information from the image sensor device (10), which may comprise, for example, a camera (13) arranged on the head of the user and an additional camera (12). After digitising the requested image information, the image sensor device (10) sends this to the central unit (30). The computer graphics processing unit (32) in the central unit (30) imports the image information (8) from the image sensor device (10) as dynamic textures into the 3D world in real time. The central unit (30) transfers current image information, based on the position and viewing direction of the user, from the 3D world to the display device (40).

With a device and method for indirect vision according to the invention, the image sensors need not be arranged in the vicinity of the display device/user. The user may be in an optional physical place but virtually be in the place of the image sensors. The invention can be used in many applications, both military and civilian, such as in a combat vehicle, in an airborne platform (for instance a pilotless reconnaissance aircraft), in a remote controlled miniature vehicle or in a larger vehicle (for instance a mine vehicle) or in a combat vessel (for example to replace the optical periscope of the submarine). It can also be borne by man and be used by the individual soldier.

The information from a number of image sensors (cameras) is placed as dynamic textures (i.e. the textures are changed in real time based on outside information ) on a surface in a virtual 3D world. As a result, distortions from camera lenses can be eliminated by changing the virtual surface on which the camera image is placed as a dynamic texture. This change can be in the form of a bend for instance. The surfaces on which the dynamic textures are placed can in a virtual 3D world be combined with other surfaces to give the user reference points, such as the interior of a combat vehicle. The head position sensor provides information about the direction and position of the head of the user, in up to six degrees of freedom. With this information, the central unit can by the computer graphics processing unit handle all these surfaces and display relevant image information to the user.

The invention can mix three-dimensional, 3D, virtual image information into the image of the surroundings recorded by the image sensors. For example, a virtual combat vehicle can be imported into the image to mark that here stands a combat vehicle. The real combat vehicle can for various reasons be hidden and difficult to discover. The virtual combat vehicle can be a 3D model with applied textures. The model can be illuminated by computer graphics so that shadows on and from the model fit into reality.

To allow the user of the invention to better orient himself in relation to the surroundings recorded by the image sensors and the interior of the combat vehicle, it may be advantageous that, for example, a virtual interior can be mixed into images of the surroundings so that the user can use this interior as a reference.

The invention can be used in a wider sense than merely recording and displaying image information. When, for instance, a combat vehicle equipped with a device and/or a method according to the invention is on a mission, it may be advantageous if the crew can prepare before an mission, that is plan an mission. This preparation may include malting the mission virtually. An example of how this virtual mission can be performed will be described below.

An aircraft, with pilot or pilotless, is sent away over the area in which the mission is planned. This aircraft carries equipment for 3D mapping of the surroundings, which includes collection of data, data processing and modelling of the 3D world, which results in a 3D model of the surroundings. In such a 3D model, also dynamic effects can be introduced, such as threats, fog, weather and an optional time of the day. The mission can thus be trained virtually and different alternatives can be tested.

When a 3D model of the surroundings is available, it can also be used during the actual mission. If real time positioning of the combat vehicle is possible, for instance image sensor data from the surroundings can be mixed with the 3D model, which can provide a strengthened experience of the surroundings.

The invention can apply a 3D model which in real time by computer engineering has been modelled based on information from the image sensors. The method is referred to as “Image Based Rendering” where properties in the images are used to build the 3D model.

In a general solution employing a general computer graphics technology, all possible 2D and 3D virtual information as described above can quickly be mixed with the image sensor images and then be displayed to the user in a manner desirable for the user. Previously known systems, such as STTV, lack these options and at the most simple 2D information can be superimposed.

1. A device for displaying an image of the surroundings to a user (90), comprising an image sensor device (10), which records image information of a surrounding world, connected via a transmission device (20) to a central unit (30), and a head-mounted display device (40), where the central unit (30) displays images from the image sensor device (10), characterised in that the device comprises a head position sensor (51) detecting the position (52) and viewing direction (53) of the user;
the central unit (30) comprises a computer graphics processing unit (32);
the central unit (30) generates a virtual 3D world;
the central unit (30) projects image information (8) in real time from the image sensor device (10) as textures in the 3D world; and
the central unit (30) displays parts of the 3D world on the display device (40) in real time.

2. A device as claimed in claim 1, characterised in that that part of the 3D world which is displayed on the display device (40) is determined by information from the head position sensor (50).

3. A device as claimed in claim 1, characterised in that the central unit (30) projects stored image information (8) as textures in the 3D world.

4. A device as claimed in claim 1, characterised in that the virtual 3D world is in the form of part of a cylinder, a sphere or a semi-sphere.

5. A device as claimed in claim 1, characterised in that the transmission channel (20) is bidirectional so that only the images requested by the central unit are sent to the central unit (30).

6. A device as claimed in claim 1, characterised in that the display device (40) is a display to be carried in connection with the user's eyes, for instance a head-mounted miniature display.

7. A device as claimed in claim 1, characterised in that image sensor device (10) comprises means for digitising the images from the image sensors.

8. A device as claimed in claim 1, characterised in that the image sensor device (10) comprises a camera (13) arranged close to the user, preferably on the user's head.

9. A device as claimed in claim 1, characterised in that the image sensor device (10) comprises an additional camera (12).

10. A device as claimed in claim 1, characterised in that the central unit (30) projects virtual objects in the 3D world.

11. A device as claimed in claim 1, characterised in that the device comprises two or more head position sensors (51) connected to two or more users (90) and two or more display devices (40) to show corresponding parts of the 3D world to the respective users (90).

12. A method of displaying an image of the surroundings to a user (90), comprising an image sensor device (10) which records image information (8) of a surrounding world, a transmission device (20), a central unit (30), a display device (40) and a head position sensor (50), characterised in that
the central unit (30) comprising a computer graphics processing unit (32) generates a virtual 3D world;
the head position sensor (50) sends information about the position (52) and the viewing direction (53) of the user to the central unit (30);
the central unit imports virtually the user (90) into the virtual 3D world based on the information from the head position sensor (50);
the image sensor device (10) sends image information (8) to the central unit (30) through the transmission device (20);
the computer graphics processing unit (32) projects in real time image information (8) from the image sensor device (10) as textures in the 3D world in real time;
the central unit (30) sends the parts of the 3D world which are positioned in an area around the viewing direction of the user to the display device (40) to be displayed.

13. A method as claimed in claim 12, characterised in that the image sensor device (10) digitises the images (8).

14. A method as claimed in claim 12, characterised in that the central unit (30) sends a request to the image sensor device (10) for the image information (8) that is to be displayed.

15. A method as claimed in claim 14, characterised in that the image sensor device (10) sends the requested image information (8) to the central unit (30).

16. A method as claimed in claim 12, characterised in that the central unit (30) imports into the 3D world an interior of a vehicle (5) or the like to give the user (90) one ore more reference points.

17. A method as claimed in claim 12, characterised in that the central unit (30) imports into the 3D world a virtual object, for instance a combat vehicle or a house, to assist the user in obtaining a better image of the surroundings.

18. A method as claimed in claim 12, characterised in that the central unit (30) imports into the 3D world image information from a camera in the vicinity of the user, preferably a camera (13) on the user's head.

19. A method as claimed in any one of claim 12, characterised in that the central unit (30) imports into the 3D world image information from an additional camera (12).

20. A method as claimed in claim 12, characterised in that the virtual 3D world is in the form of part of a cylinder, a sphere or a semi-sphere.
